(19) United States
(12) Patent Application Publication
(10) Pub. No.: US 2013/0282727 A1
(43) Pub. Date: Oct. 24, 2013

(54) UNEXPECTEDNESS DETERMINATION SYSTEM, UNEXPECTEDNESS DETERMINATION METHOD AND PROGRAM

(71) Applicants: Yusuke Muraoka, Tokyo (JP); Dai Kusui, Tokyo (JP); Hironori Mizuguchi, Tokyo (JP); Yukitaka Kusumura, Tokyo (JP)

(72) Inventors: Yusuke Muraoka, Tokyo (JP); Dai Kusui, Tokyo (JP); Hironori Mizuguchi, Tokyo (JP); Yukitaka Kusumura, Tokyo (JP)

(73) Assignee: NEC CORPORATION, Minato-ku, Tokyo (JP)

(21) Appl. No.: 13/978,811

(22) PCT Filed: Jan. 6, 2012
(86) PCT No.: PCT/JP2012/050650

§ 371 Date: Jul. 9, 2013

(30) Foreign Application Priority Data
Jan. 12, 2011 (JP) 2011-003755

(51) Int. Cl. G06F 17/30

(52) U.S. Cl. CPC G06F 17/30598
USPC 707/740

(57) ABSTRACT

The present invention more suitably determines whether a combination of words is an unexpected combination by the use of a smaller corpus. Disclosed is an unexpectedness determination system provided with: category identifying means which identifies a category to which a word belongs; category co-occurrence frequency identifying means which identifies a category co-occurrence frequency between two categories; unexpectedness index calculating means which calculates an index representing a degree of unexpectedness of a combination of two words. The category identifying means identifies a first category, to which an inputted first word belongs, and a second category, to which an inputted second word belongs, the category co-occurrence frequency identifying means identifies the category co-occurrence frequencies between the first category and categories other than the first category, and the unexpectedness index calculating means calculates an index representing the degree of unexpectedness of a combination of the first word and the second word on the basis of the category co-occurrence frequency identified by the category co-occurrence frequency identifying means.

### TECHNICAL FIELD

The present invention relates to an unexpectedness determination system, an unexpectedness determination method and a program, and in particular, relates to an unexpectedness determination system, an unexpectedness determination method and a program which can determine an unexpected combination of words.

### BACKGROUND ART

For example, in such as an idea support system and a recommendation system of topics which a user might have an interest, it is performed to present a word which is not in natural relation but is in relation of an unexpected combination.

An example of an unexpectedness determination system which presents a word which is in relation of an unexpected combination is disclosed in patent document 1.

A related word extraction device disclosed in patent document 1 includes a component which is a degree of relation calculation unit 13a. The degree of relation calculation unit 13a extracts an unexpected word for a word called a theme.

In patent document 1, a related word with unexpectedness is defined as a related word which a user does not know.

Inputs to the degree of relation calculation unit 13a are the word called the theme and other words.

The degree of relation calculation unit 13a refers to a storage device storing a set of words made correspond to the theme and a storage device storing a search history for each person. And the degree of relation calculation unit 13a checks a co-occurrence frequency between the words among the word set corresponding to the theme and a word to be evaluated in the search history for each person, and when the co-occurrence frequency is small, calculates the degree of unexpectedness of the word to the theme as large.
Patent Document 1: Japanese Unexamined Patent Application Publication No. 2004-310404

### SUMMARY OF INVENTION

### Technical Problem

The related word extraction device described in patent document 1 determines a combination of words as an unexpected combination of words when a co-occurrence frequency in a specific corpus is small.

The first problem which the related word extraction device mentioned above has is, if the corpus is small, the co-occurrence frequency becomes small for the unexpected combination of words and for the not-unexpected combination of words, and they are determined as “unexpected”.

The second problem which the related word extraction device mentioned above has is, for an object which comes into the world newly, since documents which write about the object is few, any word is determined as “unexpected”. For example, even though relation between a name of a western sweet shop just after new opening (an example: “AA confectionery”) and a name of western sweets (an example: “shortcake”) is not unexpected, the related word extraction device mentioned above determines the combination of these words as “unexpected”.

The main object of the present invention is to provide an unexpectedness determination system, an unexpectedness determination method and a program which solves the problems mentioned above.

### Technical Solution

An unexpectedness determination system of one aspect of the present invention comprises category identifying means for identifying a category to which a word belongs; category co-occurrence frequency identifying means for identifying a category co-occurrence frequency between two categories; and unexpectedness index calculating means for calculating an index representing a degree that a combination of two words is unexpected, wherein the category identifying means identifies a first category to which an inputted first word belongs and a second category to which an inputted second word belongs, the category co-occurrence frequency identifying means identifies the category co-occurrence frequencies between the first category and categories other than the first category, and the unexpectedness index calculating means calculates an index representing the degree of that a combination of the first word and the second word is unexpected on the basis of the category co-occurrence frequencies identified by the category co-occurrence frequency identifying means.

An unexpectedness determination method of one aspect of the present invention comprises identifying a first category to which an inputted first word belongs and a second category to which an inputted second inputted word belongs; identifying category co-occurrence frequencies between the first category and categories other than the first category; and calculating an index representing a degree representing that a combination of the first word and the second word is unexpected on the basis of the category co-occurrence frequency, wherein the index by the calculation concerned is one such that the smaller the category co-occurrence frequency between the first category and the second category is than the category co-occurrence frequencies between the first category and categories other than the first category and the second category, the larger the degree that the combination of the first word and the second word is unexpected becomes.

A program of one aspect of the present invention causes a computer to execute a process which identifies a first category to which an inputted first word belongs and a second category to which an inputted second word belongs; a process which identifies category co-occurrence frequencies between the first category and categories other than the first category; and a process which calculates an index representing a degree that a combination of the first word and the second word is unexpected on the basis of the category co-occurrence frequencies, wherein the index by the calculation concerned is one such that the smaller the category co-occurrence frequency between the first category and the second category is than the category co-occurrence frequencies between the first category and categories other than the first category and the second category, the larger the degree that the combination of the first word and the second word is unexpected becomes.

### Advantageous Effects

The unexpectedness determination system, the unexpectedness determination method and the program according to the present invention makes it possible to more suitably determine whether a combination of words is unexpected by the use of a smaller corpus.

### BRIEF DESCRIPTION OF DRAWINGS

FIG. 1 is a block diagram showing a structure of an unexpectedness determination system according to the first exemplary embodiment of the present invention.

FIG. 2 is a flow chart illustrating processing operation of an unexpectedness determination system according to the first exemplary embodiment of the present invention.

FIG. 3 is a figure illustrating an example of data which a word frequency storage unit 36 includes.

FIG. 4 is a figure illustrating an example of data which a word co-occurrence frequency storage unit 35 includes.

FIG. 5 is a figure illustrating an example of data which a category storage unit 31 includes.

FIG. 6 is a figure illustrating an example of data which a category co-occurrence frequency storage unit 32 includes.

FIG. 7 is a figure illustrating an example of data which a category frequency storage unit 33 includes.

FIG. 8 is a figure illustrating an example of data which a super-ordinate category storage unit 34 includes.

FIG. 9 is a block diagram showing a structure of an unexpectedness determination system according to the second exemplary embodiment of the present invention.

FIG. 10 is a block diagram illustrating an example of elements of which a computer is structured.

### DESCRIPTION OF EMBODIMENTS

Next, exemplary embodiments of the present invention will be described in detail with reference to drawings.

### The First Exemplary Embodiment

Definition of terminology used in the description below is given as follows.

“Category” is a concept which represents a set of words possessing certain meanings, characteristics, classification and so on in common. For example, the category corresponding to the words such as “Mikasayama” and “Mt. Fuji” is “mountain”, and the category corresponding to the words as “Mt. Fuji” and “Izu” (Japanese place name) is “Shizuoka-ken” (Japanese prefecture name). A word belonging to a category represents the word classified into the category. In the example mentioned above, the words which belong to the category “mountain” are “Mikasayama” and “Mt. Fuji”. Also, a category may further belong to a different category. For example, the category “Shizuoka-ken” may belong to the category “prefecture name”.

“Corpus” is data which is collected from sentences used in the daily life such as, for example, a newspaper article and a blog article. The corpus may be used as data for judging whether two words generally tend to be referred simultaneously. In the exemplary embodiment of the present invention, the corpus is used as data for calculating “word frequency” and “co-occurrence frequency” described below.

“Word frequency” is a number of times which a certain word appears in the corpus.

“Co-occurrence frequency” is a number of times which, for certain two words, the two words appear simultaneously in one sentence in the corpus. The co-occurrence frequency may not be the number of times which these words appear simultaneously in one sentence, but may also be a number of times which they appear simultaneously in one document.

“Category frequency” is a total number of numbers of times which, for a certain category, a word belonging to the category appears in the corpus.

“Category co-occurrence frequency” is, for two certain categories A and B, a total number of the co-occurrence frequency of a word which belongs to the category A and a word which belongs to the category B. That is, the category co-occurrence frequency is the total number of numbers of times which the word belonging to the category A and the word belonging to the category B appear simultaneously in one sentence in the corpus. The category co-occurrence frequency may not be the number of times which these words appear simultaneously in one sentence, but may also be a number of times which they appear simultaneously in one document.

The corpus may also be one which collected word pairs which are in linked relation in an article of Wikipedia (registered trademark). For example, in case there are links from a page of an article of “Wakakusayama” to pages of articles of “dorayaki pancake” (Japanese sweets), “a circular shaped ancient tomb with rectangular frontage” (one kind of Japanese ancient burial mounds) and “Nara” (Japanese place name), word pairs “Wakakusayama, dorayaki pancake”, “Wakakusayama, a circular shaped ancient tomb with rectangular frontage” and “Wakakusayama, Nara” are recorded as the corpus.

The co-occurrence frequency may also be a number of links between the articles which describe two words in the articles of Wikipedia. For example, concerning the page of the article of “Wakakusayama” and concerning the page of the article of “dorayaki pancake” of Wikipedia, in case total of five links appear from one page to the page of the other article, the co-occurrence frequency of the words “Wakakusayama” and “dorayaki pancake” is 5.

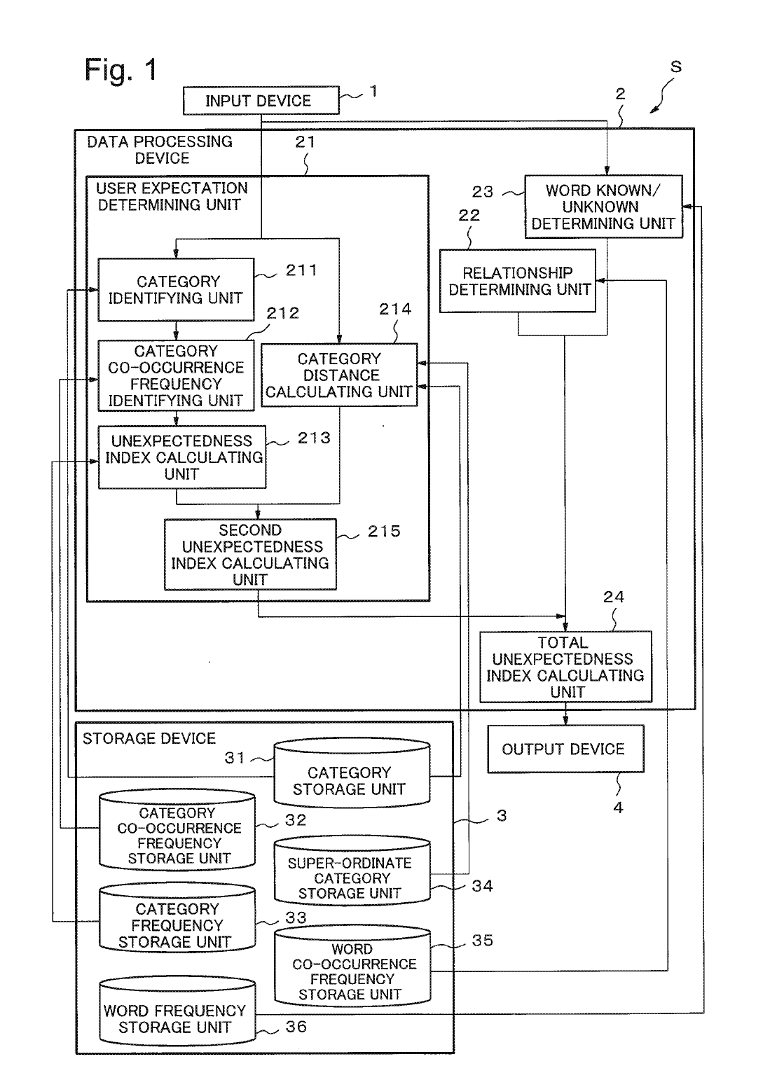

FIG. 1 is a block diagram showing a structure of an unexpectedness determination system according to the first exemplary embodiment of the present invention. An unexpectedness determination system S of FIG. 1 includes: an input device 1 such as a keyboard, a data processing device 2 which operates by program control, a storage device 3 which stores information and an output device 4 such as a display device.

The input device 1 may be a device such as the keyboard with which a user inputs data or may also be a device which inputs data from other devices by communicating, copying, or converting data.

The storage device 3 includes: a category storage unit 31, a category co-occurrence frequency storage unit 32, a category frequency storage unit 33, a super-ordinate category storage unit 34, a word co-occurrence frequency storage unit 35 and a word frequency storage unit 36. The storage device 3 may be a magnetic disk device such as a hard disk drive or may also be a memory device such as a flash memory.

The category storage unit 31 links a word and a category to which the word belongs and stores them. A plurality of the category may be given to one word. Data of the category stored in the category storage unit 31 can be created, for example, by using data of a category to which a word which each article of Wikipedia describes belongs.

The category co-occurrence frequency storage unit 32 links a set of two categories and a category co-occurrence frequency of the set of the categories in a certain corpus and stores them. Data of the co-occurrence frequency of the categories to be stored in the category co-occurrence frequency storage unit 32 can be created by counting up in the corpus the co-occurrence frequency of the words belonging to the categories stored in the category storage unit 31.

The category frequency storage unit 33 links a category and a category frequency of the category in a certain corpus and stores them. Data of the category frequency to be stored in the category frequency storage unit 33 can be created by counting up in the corpus the word belonging to the categories stored in the category storage unit 31 like the category co-occurrence frequency mentioned above.

The word co-occurrence frequency storage unit 35 links a word pair and a co-occurrence frequency of the word pair and stores them.

The super-ordinate category storage unit 34 links a category and other category to which the category belongs (hereinafter referred to as “super-ordinate category”) and stores them. A category may belong to a plurality of super-ordinate categories. Data of the super-ordinate category to be stored in the super-ordinate category storage unit 34 can be created, for example, by using data of another category to which a category of Wikipedia belongs.

The word frequency storage unit 36 stores, for a word, a word frequency of the word in a certain corpus. Data of the word frequency to be stored in the word frequency storage unit 36 can be created by counting up in the corpus a frequency which the word appears.

The data processing device 2 includes: a user expectation determining unit 21, a relationship determining unit 22, a word known/unknown determining unit 23 and a total unexpectedness index calculating unit 24.

The user expectation determining unit 21 includes: a category identifying unit 211, a category co-occurrence frequency identifying unit 212, an unexpectedness index calculating unit 213, a category distance calculating unit 214 and a second unexpectedness index calculating unit 215.

Next, an operation of the unexpectedness determination system according to the first exemplary embodiment of the present invention will be described in detail with reference to FIG. 1. First, two words are inputted to the input device 1. These two input words are inputted to the user expectation determining unit 21, the relationship determining unit 22 and the word known/unknown determining unit 23 respectively.

The word known/unknown determining unit 23 refers to the word frequency storage unit 36 for each of the inputted two words and obtains a word frequency thereof. When the obtained word frequency is smaller than a certain predetermined threshold value, the word known/unknown determining unit 23 inputs a code representing that the inputted word is unknown to the total unexpectedness index calculating unit 24. Otherwise, the word known/unknown determining unit 23 inputs to the total unexpectedness index calculating unit 24 a numerical value such as, the larger the word frequency is, the larger the numerical value becomes, for example, logarithm of the word frequency as a word known degree of the inputted word.

The relationship determining unit 22 refers, for a combination of inputted two words, to the word co-occurrence frequency storage unit 35 and determines whether the word co-occurrence frequency is not 0. In case the word co-occurrence frequency is 0, the relationship determining unit 22 determines that the inputted two words are words with no relation. And the relationship determining unit 22 inputs a code representing that they are words with no relation to the total unexpectedness index calculating unit 24. In case the word co-occurrence frequency is not 0, the relationship determining unit 22 determines that the inputted two words are words with relation. And the relationship determining unit 22 inputs a code representing that a pair of the input words has relation to the total unexpectedness index calculating unit 24.

Two words inputted to the user expectation determining unit 21 are inputted to the category identifying unit 211 and the category distance calculating unit 214. The category identifying unit 211 searches, for inputted two words, categories to which the respective words belong from the category storage unit 31. And combinations of the categories searched for one word and the categories searched for the other word are all inputted to the category co-occurrence frequency identifying unit 212.

The category co-occurrence frequency identifying unit 212 performs, for each combination of the categories inputted from the category identifying unit 211, following processing. The category co-occurrence frequency identifying unit 212 makes the respective categories a key and searches the category co-occurrence frequencies of the key category and each of all other categories from the category co-occurrence frequency storage unit 32. And the category co-occurrence frequency identifying unit 212 inputs the combination of the inputted categories and the category co-occurrence frequency information searched to the unexpectedness index calculating unit 213.

Here, the category co-occurrence frequency identifying unit 212 adopted a means to search the category co-occurrence frequencies registered in a database in advance. Meanwhile, the category co-occurrence frequency identifying unit 212 may count the co-occurrence frequencies of the categories for each inquiry.

Hereinafter, a total frequency of a word belonging to a category A is represented as “NA”, and a category co-occurrence frequency of a category A and a category B is represented as “C_AB”. Also, a set of all the categories will be represented as “Category”.

Further, in an description hereinafter, a character string which carries English letters on right and left side with “_” inserted in between such as “N_A” corresponds to a character string in [formula 1] to [formula 8] which carries the English letters on the right side of “_” at lower right of the English letters on the left side of “_”. For example, “C_AX” corresponds to a character string which is inserted in a parenthesis on the left side of an equal sign “=” of [formula 1], that is, a character string which carries “AX” at lower right of “C”. Also, a character string which includes “̂” and “_” such as “p̂A_AB” corresponds to a character string in [formula 1] to [formula 8] which carries the English letters on the right side of “̂” at upper right of the English letters on the left side of “̂”, and the English letters on the right side of “_” at lower right of the English letters on the left side of “̂”. For example, “p̂A_AB” corresponds to a character string on the left side of an equal sign “=” of [formula 3], that is, a character string which carries “A” at upper right of “p” and “AB” at lower right of “p”.

In case a category pair which is inputted from the category co-occurrence frequency identifying unit 212 and which is to be evaluated is a category A and a category B, the unexpectedness index calculating unit 213 calculates, for a category co-occurrence frequency of the category A and the category B, two kinds of scores representing unexpectedness. Further, in the description hereinafter, an index representing a degree that a combination of two words or categories is unexpected is called just as “score”. Both scores are calculated following the procedures such as:

(1) Predict distribution of the category co-occurrence frequency of the category A and the category B, and

(2) When the distribution of the co-occurrence frequency is decided, calculate how rare the actual category co-occurrence frequency of the category A and the category B is under the distribution (p value).

Since there are two kinds of distributions considered in (1), the unexpectedness index calculating unit 213 calculates two kinds of scores. Hereinafter, each score is called “a score on the basis of the category A” and “a score on the basis of the category B”.

Hereinafter, a method of calculation of “the score on the basis of the category A” will be described. “The score on the basis of the category A” is the following.

(1) Predict distribution of the category co-occurrence frequency of the category A and the category B:

As prediction of the category co-occurrence frequency of the category A and the category B, the unexpectedness index calculating unit 213 performs prediction of the distribution of the category co-occurrence frequency. The unexpectedness index calculating unit 213 first obtains the co-occurrence frequency of the category A and other categories for the prediction of the distribution. For an arbitrary category X, it is assumed that a category co-occurrence frequency C_AX of the category A and the category X follows binomial distribution with a sample size of N_A×N_X and a parameter p which does not depend on X. In other words, it is assumed that probability Prob(C_AX) that the category co-occurrence frequency of the category A and the category X will be C_AX will be [formula 1] below. Further, a parenthesis on the right of an equal sign of [formula 1] represents a number of combinations which chooses a number of the lower row among a number of the upper row in the parenthesis.

$$Prob ( {C}_{AX} ) = ( \begin{matrix}{N}_{A} {N}_{X} \\ {C}_{AX}\end{matrix} ) {{p}^{{C}_{AX}} ( 1 - p )}^{{N}_{A} {N}_{X} - {C}_{AX}} \qquad [ formula 1 ]$$

Under the assumption mentioned above, when the parameter p is estimated by maximum-likelihood estimation, an estimated result will be [formula 2] below.

$$p = \frac{{\sum }_{Y ∈ \{ Category \backslash \{ A , B \} \}} {C}_{AY}}{{N}_{A} {\sum }_{Y ∈ \{ Category \backslash \{ A , B \} \}} {N}_{Y}} \qquad [ formula 2 ]$$

The unexpectedness index calculating unit 213 searches N_A and N_B from the category frequency storage unit 33.

Here, the unexpectedness index calculating unit 213 adopted a means to search the category frequencies registered in a database in advance. Meanwhile, the unexpectedness index calculating unit 213 may adopt other means. For example, the unexpectedness index calculating unit 213 may search the corpus for each inquiry and may count the category frequency.

(2) When the distribution of the co-occurrence frequency is decided, calculate how rare the actual co-occurrence frequency of the category A and the category B is under the distribution (p value):

In order to decide how rare the actual co-occurrence frequency is under the binomial distribution with the estimated parameter, the unexpectedness index calculating unit 213 uses the p value. In other words, the unexpectedness index calculating unit 213 obtains probability p̂A_AB which the co-occurrence frequency becomes smaller than the realized value C_AB under the estimated distribution. p̂A_AB is represented by [formula 3] below.

$${p}_{AB}^{A} = {\sum }_{c = 0}^{{C}_{AB}} Prob ( c ) \qquad [ formula 3 ]$$

That this probability is small means that the co-occurrence frequency of the category A and the category B is smaller than other ones. Accordingly, the unexpectedness index calculating unit 213 calculates 1−p̂A_AB as the score.

As for the calculation of “the score on the basis of the category B”, the category A and the category B may be exchanged in the procedure above. Final score of the category pair may be obtained, for example, by calculating an average of “the score on the basis of the category A” and “the score on the basis of the category B”. Also, in case there are a plurality of category pairs, final score of the category pairs may be obtained by calculating an average of the scores of these category pairs.

Or, only the score on the basis of one category is calculated and this may be made the final score of the category pair. For example, “the score on the basis of the category A” may be calculated and this may be made the final score of the category pair.

The method of calculation mentioned above considers the distribution from the co-occurrence frequency with all other categories. However, in the method of calculation mentioned above, the co-occurrence frequency to be paid attention may be limited. For example, in case a user is not interested in relation between places such as “mountain” and “building”, there may be a case where only the relation between words related to places and words related to other than places may be considered. In this case, categories are divides into two such as a category group related to places and a category group related to other than places, and only the co-occurrence of the categories of places and the categories of other than the places is paid attention. The calculation in this case may be made such that, in the method mentioned above, “other categories” are made not all other categories but, in case the category A is a category related to places, they may be made “categories other than places”.

The unexpectedness index calculating unit 213 calculates the score as described above on the basis of the category pair inputted from the category co-occurrence frequency identifying unit 212, the co-occurrence frequency information inputted from the category co-occurrence frequency identifying unit 212 and the category frequency information searched from the category frequency storage unit 33. And the unexpectedness index calculating unit 213 inputs the calculated score to the second unexpectedness index calculating unit 215.

The category distance calculating unit 214 calculates distance to a common super-ordinate category to which two words inputted to the input device 1 belong as will be stated below. First, the category distance calculating unit 214 searches, for each of the two words inputted to the input device 1, categories to which each of the words belongs from the category storage unit 31 and the super-ordinate category storage unit 34. Next, the category distance calculating unit 214 traces super-ordinate categories of the category to which each of the words belongs one by one and obtains a closest category which is among the super-ordinate categories of both words and which is in common. The closest category means a category with a smallest number of categories traced. And the category distance calculating unit 214 inputs the number of smaller one among the respective numbers of categories traced to the common super-ordinate category closest from each of the two words as the distance between the two words to the second unexpectedness index calculating unit 215. Further, in the description hereinafter, the distance obtained by the calculation mentioned above is called “category distance”.

The second unexpectedness index calculating unit 215 calculates an index of unexpectedness on the basis of the score inputted from the unexpectedness index calculating unit 213 and the category distance inputted from the category distance calculating unit 214, and inputs it to the total unexpectedness index calculating unit 24. In detail, the second unexpectedness index calculating unit 215 inputs a numerical value such that the larger the score is and the larger the category distance is, the larger it becomes to the total unexpectedness index calculating unit 24. For example, the second unexpectedness index calculating unit 215 calculates a product of the score and the category distance and inputs it to the total unexpectedness index calculating unit 24.

When the code inputted from the relationship determining unit 22 represents that they are words with no relation, the total unexpectedness index calculating unit 24 outputs 0 to the output device 4 as the final score. Also, when the code inputted from the word known/unknown determining unit 23 represents that the word is unknown, the total unexpectedness index calculating unit 24 outputs 0 to the output device 4 as the final score.

On the other hand, in case the code inputted from the relationship determining unit 22 represents that they are words with relation and the code inputted from the word known/unknown determining unit 23 is not the one which represents that the word is unknown, the following processing is performed. The total unexpectedness index calculating unit 24 first calculates a numerical value such that the larger the score inputted from the user expectation determining unit 21 and the word known degree inputted from the word known/unknown determining unit 23, the larger it becomes as the final score. This calculation may also be one which, for example, obtains a product of the score inputted from the user expectation determining unit 21 and the word known degree inputted from the word known/unknown determining unit 23. Instead of obtaining the product, the total unexpectedness index calculating unit 24 may make the score inputted from the user expectation determining unit 21 as the final score just as it is. And the total unexpectedness index calculating unit 24 outputs the final score to the output device 4.

The output device 4 outputs the inputted score.

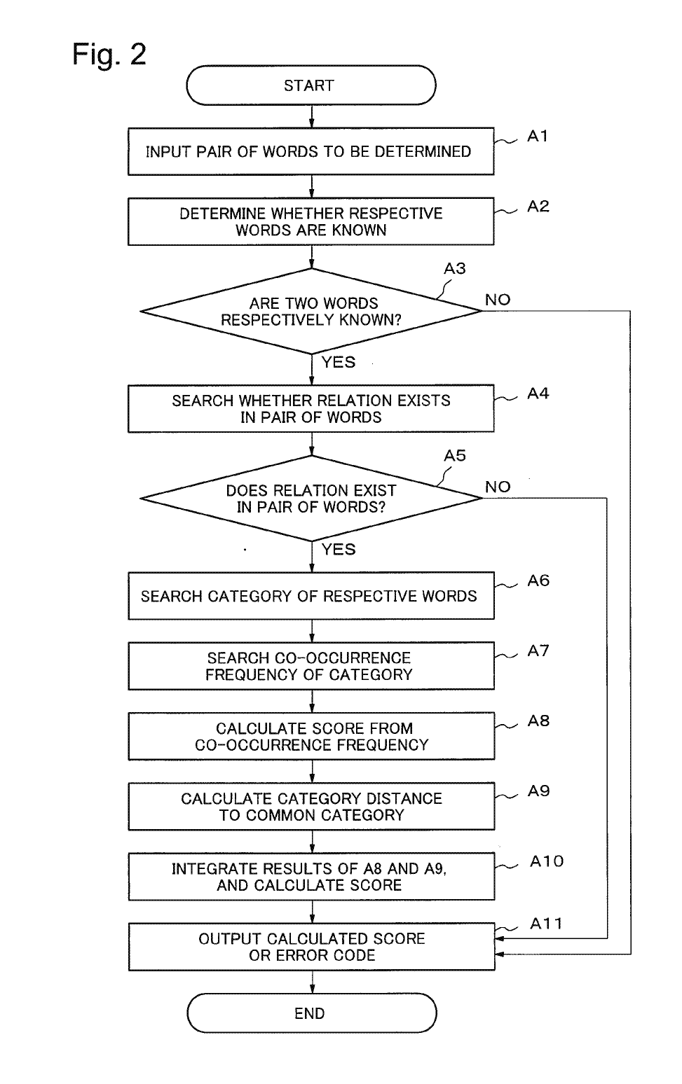

Next, processing operation of the unexpectedness determination system according to the first exemplary embodiment of the present invention will be described using FIG. 2. FIG. 2 is a flow chart illustrating processing operation of the unexpectedness determination system according to the first exemplary embodiment of the present invention.

First, a combination of words is inputted to the input device 1. The input device 1 inputs the combination of the words to the user expectation determining unit 21, the relationship determining unit 22 and the word known/unknown determining unit 23 respectively. The combination of the words inputted to the user expectation determining unit 21 is further inputted to the category identifying unit 211 and the category distance calculating unit 214 (Step A1).

Next, for each of the two words inputted in Step A1, the word known/unknown determining unit 23 inputs to the total unexpectedness index calculating unit 24 a word known degree or a code representing that the word is unknown. (Step A2).

Next, in case one inputted to the total unexpectedness index calculating unit 24 is the code representing that the word is unknown (NO of Step A3), the processing advances to Step A11 and an error code is outputted. Otherwise (YES of Step A3), the processing advances to Step A4 (Step A3).

Next, the relationship determining unit 22 determines whether there is relation in the combination of the words inputted in Step A1. And the relationship determining unit 22 inputs a code representing that they are words with no relation or a code representing that they are words with relation to the total unexpectedness index calculating unit 24 (Step A4).

Next, when the one inputted to the total unexpectedness index calculating unit 24 in Step A4 is the code representing that they are words with relation (YES of Step A5), the processing advances to Step A6. When the one inputted to the total unexpectedness index calculating unit 24 is the code representing that they are words with no relation (NO of Step A5), the processing advances to Step A11, and an error code which shows that there exists no relationship is outputted from the output device 4 (Step A5).

The category identifying unit 211 searches, for the combination of the words inputted in Step A1, the category to which each belongs and inputs the category to the category co-occurrence frequency identifying unit 212 (Step A6).

Next, the category co-occurrence frequency identifying unit 212 searches a co-occurrence frequency of a combination of the inputted categories and co-occurrence frequencies of the respective categories and other categories. And the category co-occurrence frequency identifying unit 212 inputs the combination of the inputted categories and all of the results of the searched co-occurrence frequencies to the unexpectedness index calculating unit 213 (Step A7).

Next, the unexpectedness index calculating unit 213 calculates a score on the basis of the combination of the inputted categories and the co-occurrence frequencies related to the combination of the categories, and outputs the score to the second unexpectedness index calculating unit 215 (Step A8).

The category distance calculating unit 214 calculates category distance to a common super-ordinate category of the combination of the words inputted in Step A1 and outputs the category distance to the second unexpectedness index calculating unit 215 (Step A9).

Next, the second unexpectedness index calculating unit 215 calculates a score on the basis of the score inputted in Step A8 and the category distance to the common category inputted in Step A9 and inputs the score to the total unexpectedness index calculating unit 24 (Step A10).

Finally, the total unexpectedness index calculating unit 24, when the code representing that the word is unknown is inputted in Step A3, outputs that code, and when the code representing that they are words with no relation is inputted in Step A5, outputs that code. In case otherwise, the total unexpectedness index calculating unit 24 calculates a final score on the basis of the word known degree inputted in Step A2 and the score calculated in Step A8 or in Step A10, and outputs the final score to the output device 4. And the output device 4 outputs the inputted final score (Step A11).

Next, processing operation of the unexpectedness determination system according to the first exemplary embodiment of the present invention will be described using an example of specific data.

As categories, it is supposed that there exist “mountain”, “sweet shop”, “sweets” and “plant”.

In Step A1, it is supposed that “dorayaki pancake” and “Wakakusayama” were inputted as two words from the input device 1. These two words are inputted to the user expectation determining unit 21, the relationship determining unit 22 and the word known/unknown determining unit 23. These two words inputted to the user expectation determining unit 21 are further inputted to the category identifying unit 211 and the category distance calculating unit 214.

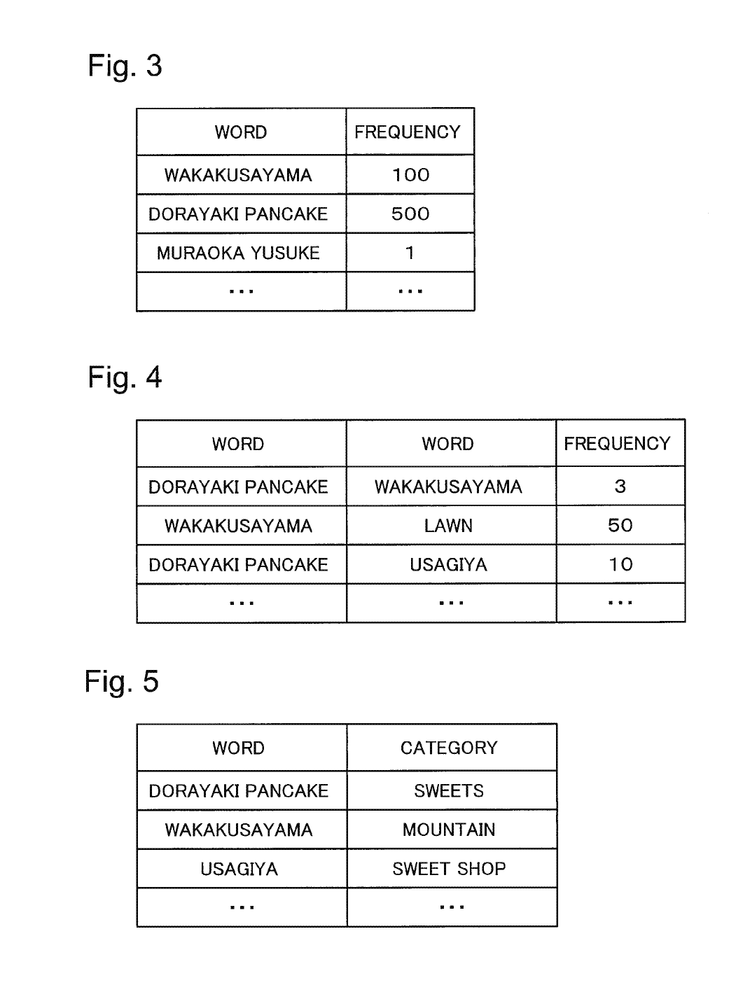

FIG. 3 illustrates an example of data which the word frequency storage unit 36 includes. In Steps A2 and A3, the word known/unknown determining unit 23 searches the word frequency storage unit 36 with “dorayaki pancake” and “Wakakusayama” as keys and obtains word frequencies of 100 and 500. Here, it is supposed that a rule was set up which makes a word as unknown when the frequency is no more than 50. Since these two input words are determined by this rule that they are known words, the word known/unknown determining unit 23 inputs word known degrees of log(100) and log(500) to the total unexpectedness index calculating unit 24. And the processing advances to Step A4.

FIG. 4 illustrates an example of data which the word co-occurrence frequency storage unit 35 includes. In Steps A4 and A5, the relationship determining unit 22 searches the word co-occurrence frequency storage unit 35 with “dorayaki pancake” and “Wakakusayama” as keys. Since a combination of these words exists, the relationship determining unit 22 inputs a code representing that they are words with relation to the total unexpectedness index calculating unit 24. And the processing advances to Step A6.

FIG. 5 illustrates an example of data which the category storage unit 31 includes. In Step A6, the category identifying unit 211 searches the category storage unit 31 with “dorayaki pancake” as a key and obtains a category of “sweets”. Also, the category identifying unit 211 searches the category storage unit 31 with “Wakakusayama” as a key and obtains a category of “mountain”. And the category identifying unit 211 inputs a combination of the categories of “sweets” and “mountain” to the category co-occurrence frequency identifying unit 212.

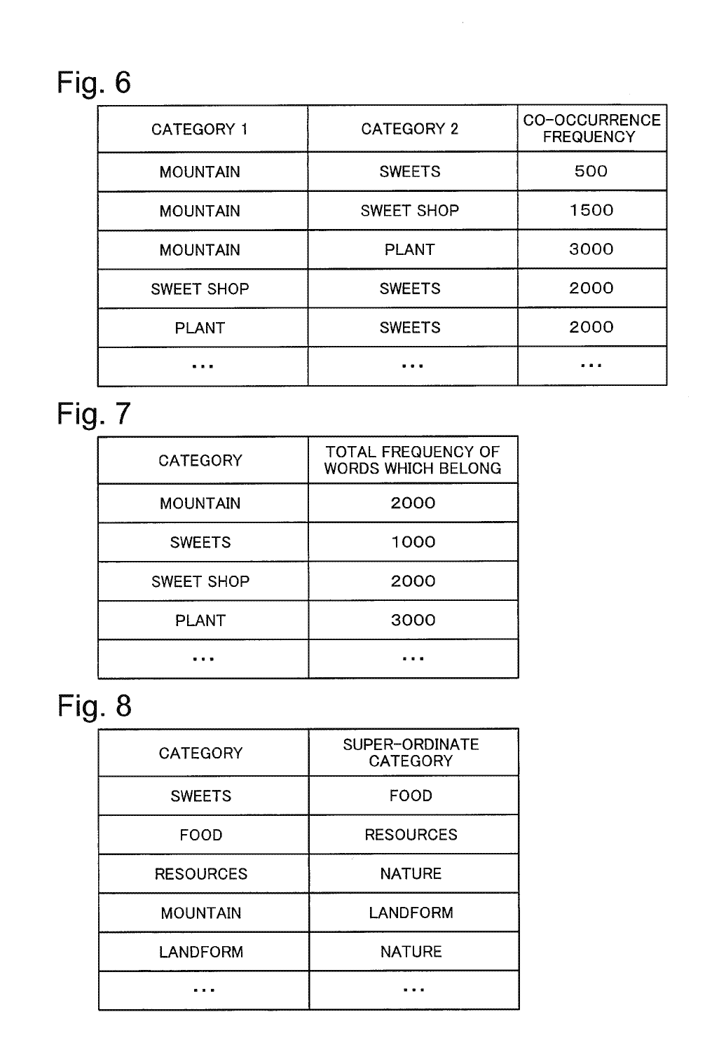

FIG. 6 illustrates an example of data which the category co-occurrence frequency storage unit 32 includes. In Step A7, the category co-occurrence frequency identifying unit 212 refers to the category co-occurrence frequency storage unit 32 and searches co-occurrence frequencies of “sweets” and the categories of each of “mountain”, “sweet shop” and “plant”. In the same way, the category co-occurrence frequency identifying unit 212 searches co-occurrence frequencies of “mountain” with the categories of each of “sweets”, “sweet shop” and “plant”. And the category co-occurrence frequency identifying unit 212 inputs the combination of the categories of “sweets” and “mountain” and all of the searched co-occurrence frequencies to the unexpectedness index calculating unit 213.

FIG. 7 illustrates an example of data which the category frequency storage unit 33 includes. In Step A8, the unexpectedness index calculating unit 213 calculates a score on the basis of “sweets” as follows.

First, parameter p is calculated by [formula 2] as

$$p = \frac{2000 + 2000}{1000 \times ( 2000 + 3000 )} = 0.0008 \qquad [ formula 4 ]$$

And probability of becoming no more than 500 under the binomial distribution with the parameter p and a sample size of 1,000×2,000=2,000,000 is calculated as follows using [formula 1], [formula 3] and [formula 4].

$${\sum }_{c = 0}^{500} ( \begin{matrix}2000000 \\ c\end{matrix} ) {( 0.0008 )}^{c} {( 1 - 0.0008 )}^{2000000 - c} \sim 0 \qquad [ formula 5 ]$$

Since p̂A_AB is evaluated to be approximately 0 as mentioned above, by calculating 1−p̂A_AB as the score, 1 is obtained as the calculation result.

The unexpectedness index calculating unit 213 also calculates a score on the basis of “mountain” similarly and as follows. That is, first, the parameter p is calculated by [formula 2] as

$$p = \frac{1500 + 3000}{2000 \times ( 2000 + 3000 )} = 0.00045 \qquad [ formula 6 ]$$

And probability of becoming no more than 500 under the binomial distribution with the parameter p and a sample size of 1,000×2,000=2,000,000 is calculated as follows using [formula 1], [formula 3] and [formula 6].

$${\sum }_{c = 0}^{500} ( \begin{matrix}2000000 \\ c\end{matrix} ) {( 0.00045 )}^{c} {( 1 - 0.00045 )}^{2000000 - c} \sim 0 \qquad [ formula 7 ]$$

Since p̂A_AB is evaluated to be approximately 0 as mentioned above, by calculating 1−p̂A_AB as the score, 1 is obtained as the calculation result.

By calculating an average of the score on the basis of “sweets” and the score on the basis of “mountain”, the unexpectedness index calculating unit 213 calculates the score as 1.

FIG. 8 illustrates an example of data which the super-ordinate category storage unit 34 includes. In Step A9, the category distance calculating unit 214 searches the category storage unit 31 and obtains “sweets” which is the category to which “dorayaki pancake” belongs and “mountain” which is the category to which “Wakakusayama” belongs. And the category distance calculating unit 214 searches the super-ordinate category storage unit 34, traces a super-ordinate category of “sweets” and a super-ordinate category of “mountain” one by one, and obtains a category “nature” which is a common super-ordinate category of “sweets” and “mountain”. Since category distance from “dorayaki pancake” to “nature” is 4 and category distance from “Wakakusayama” to “nature” is 3, the category distance calculating unit 214 calculates the category distance as 3. And the category distance calculating unit 214 inputs the calculated category distance of 3 to the second unexpectedness index calculating unit 215.

In Step A10, the second unexpectedness index calculating unit 215 calculates a score on the basis of the input of 1 from the unexpectedness index calculating unit 213 and the input of 3 from the category distance calculating unit 214. Here, a product of them, 1×3=3 is calculated. And the second unexpectedness index calculating unit 215 inputs the calculated score to the total unexpectedness index calculating unit 24.

In Step A11, the total unexpectedness index calculating unit 24 calculates a final score on the basis of the word known degrees of log(100) and log(500) inputted in Step A2 and the score of 3 inputted in Step A10. Here, 3×log(100)×log(500)=16.19382 . . . is calculated. Further, it is supposed that the base of the logarithm is 10. And the total unexpectedness index calculating unit 24 inputs the calculated final score to the output device 4, and the output device 4 outputs the inputted final score of 16.19382 . . . .

Next, processing operation of the unexpectedness determination system according to the first exemplary embodiment of the present invention in case another combination of words is inputted will be described.

First, as an example of a combination of words which is not unexpected, a case when “dorayaki pancake” and “Usagiya” which is a name of a Japanese sweet shop are inputted from the input device 1 will be described. In this case, when calculated same as Steps A1 to A8 mentioned above, the unexpectedness index calculating unit 213 calculates p̂A_AB as [formula 8].

$${\sum }_{c = 0}^{2000} {( \begin{matrix}2000000 \\ c\end{matrix} )}^{c} {\{ \frac{2000}{2000 \times ( 2000 + 1000 )} \}}^{c} {\{ 1 - \frac{2000}{2000 \times ( 2000 + 1000 )} \}}^{2000000 - c} \sim 1 \qquad [ formula 8 ]$$

Since p̂A_AB is evaluated to be approximately 1 as mentioned above, by calculating 1-p̂A_AB as a score, 0 is obtained.

On the other hand, in Step A9 mentioned above, the category distance calculating unit 214 calculates category distance as 1.

From the above, a final score will be 0. As a result, it can be determined that the combination of “dorayaki pancake” and “Wakakusayama” is higher in the score than the combination of “dorayaki pancake” and “Usagiya”, that is, it is the more unexpected combination.

Next, as an example in which a word of low popularity is included in an input, a case when “dorayaki pancake” and “Muraoka Yusuke” are given from the input device 1 will be described. In this case, since the word frequency of “Muraoka Yusuke” is 1 and smaller than 50, the word known/unknown determining unit 23 inputs an error code representing that the word is unknown to the total unexpectedness index calculating unit 24. As a result, a score representing unexpectedness of a combination of “dorayaki pancake” and “Muraoka Yusuke” is outputted as 0.

Finally, as an example of a combination of words with no relation, a case when “dorayaki pancake” and “NASA” are inputted from the input device 1 will be described. In this case, since a word co-occurrence frequency of “dorayaki pancake” and “NASA” is not registered (the word co-occurrence frequency is 0), the relationship determining unit 22 inputs an error code representing that they are words with no relation to the total unexpectedness index calculating unit 24. As a result, a score representing unexpectedness of a combination of “dorayaki pancake” and “NASA” is outputted as 0.

As above, even if a corpus is small, the unexpectedness determination system S according to the first exemplary embodiment of the present invention can determine whether a combination of words is unexpected. This is because the unexpectedness index calculating unit 213 determines unexpectedness by the use of co-occurrence frequencies of the combinations of categories whose number of kinds of combinations is smaller than that of the combinations of words. Also, by this fact, even for a word which hardly appears in the corpus such as a word which has just come to be known newly, an advantage exists that unexpectedness can be suitably determined as far as a category to which the word belongs is registered.

Also, the unexpectedness determination system S according to the first exemplary embodiment of the present invention has an advantage that the result is hardly influenced by an appearance frequency of a word to be determined in the corpus. This is because the unexpectedness index calculating unit 213 determines unexpectedness by the use of co-occurrence frequency of a category to which the word to be determined belongs and all of the other categories.

Further, the unexpectedness determination system S according to the first exemplary embodiment of the present invention can determine a combination of words of which unexpectedness is high and which arouses user's interest. This is because the relationship determining unit 22, the word known/unknown determining unit 23 and the total unexpectedness index calculating unit 24 can, for a combination of words which look unrelated at a first glance, determine relationship of the combination of the words Also, this is because, by calculating distance of the categories, the category distance calculating unit 214 and the second unexpectedness index calculating unit 215 can determine unexpectedness of a combination of words which are difficult to think that they are with relation because of their meanings being far apart.

### The Second Exemplary Embodiment

Next, the second exemplary embodiment of the present invention will be described.

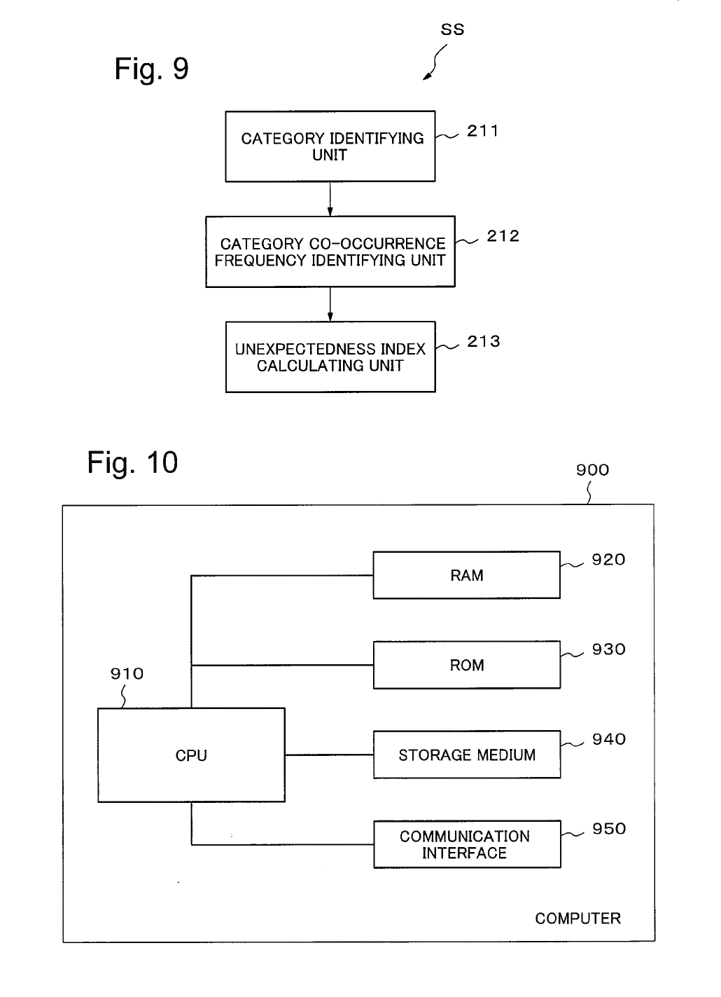

FIG. 9 is a block diagram showing a structure of an unexpectedness determination system according to the second exemplary embodiment of the present invention. An unexpectedness determination system SS of FIG. 9 includes: a category identifying unit 211, a category co-occurrence frequency identifying unit 212 and an unexpectedness index calculating unit 213.

The category identifying unit 211 identifies a category to which a word belongs.

The category co-occurrence frequency identifying unit 212 identifies a category co-occurrence frequency between two categories. The unexpectedness index calculating unit 213 calculates an index representing a degree that a combination of two words is unexpected.

In case two of a first word and a second word are inputted, the unexpectedness determination system according to the second exemplary embodiment of the present invention performs processing as follows.

First, the category identifying unit 211 identifies a first category to which the first word belongs and a second category to which the second word belongs.

Next, the category co-occurrence frequency identifying unit 212 identifies category co-occurrence frequencies between the first category and categories other than the first category.

And the unexpectedness index calculating unit 213 calculates, on the basis of the category co-occurrence frequencies which the category co-occurrence frequency identifying unit 212 identified, an index representing a degree that a combination of the first word and the second word is unexpected.

As above, even if a corpus is small, the unexpectedness determination system SS according to the second exemplary embodiment of the present invention can determine whether a combination of words is unexpected. This is because the unexpectedness index calculating unit 213 determines unexpectedness by the use of co-occurrence frequencies of the combinations of categories whose number of kinds of combinations is smaller than that of the combinations of words.

The unexpectedness determination systems according to the first and the second exemplary embodiment mentioned above may be realized by special purpose hardware or may be realized by executing a software program in a computer.

FIG. 10 is a block diagram illustrating an example of elements of which a computer is structured. A computer 900 of FIG. 10 includes: a CPU (Central Processing Unit) 910, a RAM (Random Access Memory) 920, a ROM (Read Only Memory) 930, a storage medium 940 and a communication interface 950. Components of the unexpectedness determination systems S, SS mentioned above may be realized by a program being executed in CPU 910 of the computer 900. Specifically, the components of the unexpectedness determination systems S, SS described in FIG. 1 (, FIG. 2) and FIG. 9 mentioned above may be realized by the CPU 910 reading a program from the ROM 930 or the storage medium 940 and by executing it. And in such a case, the present invention is structured from a code of the computer program concerned or a storage medium (for example, such as the storage medium 940, or a memory card which can be attached/detached and is not illustrated) in which the code of the computer program is stored.

While the invention has been particularly shown and described with reference to preferred exemplary embodiments thereof, the invention is not limited to these embodiments. It is obvious that various changes in form and details may be made therein without departing from the spirit and scope of the present invention as defined by the claims.

This application is based upon and claims the benefit of priority from Japanese patent application No. 2011-003755, filed on Jan. 12, 2011, the disclosure of which is incorporated herein in its entirety by reference.

### INDUSTRIAL APPLICABILITY

The present invention can be applied to a system which determines, for a combination of two words, a degree of unexpectedness of the combination.

Also, the present invention can be applied to a system which searches and presents an unexpected keyword related to an inputted keyword.

Also, the present invention can be applied to a system which searches and recommends unexpected information from a keyword which is included in a web page which a user is at present viewing.

### REFERENCE SIGNS LIST

S, SS Unexpectedness determination system
1 Input device
2 Data processing device
21 User expectation determining unit
211 Category identifying unit
212 Category co-occurrence frequency identifying unit
213 Unexpectedness index calculating unit
214 Category distance calculating unit
215 Second unexpectedness index calculating unit
22 Relationship determining unit
23 Word known/unknown determining unit
24 Total unexpectedness index calculating unit
3 Storage device
31 Category storage unit
32 Category co-occurrence frequency storage unit
33 Category frequency storage unit
34 Super-ordinate category storage unit
35 Word co-occurrence frequency storage unit
36 Word frequency storage unit
4 Output device
900 Computer
910 CPU
920 RAM
930 ROM
940 Storage medium
950 Communication interface

What is claimed is:

1.-10. (canceled)

11. An unexpectedness determination system comprising:
a category identifying unit which identifies a category to which a word belongs;
a category co-occurrence frequency identifying unit which identifies a category co-occurrence frequency between two categories; and
an unexpectedness index calculating unit which calculates an index representing a degree that a combination of two words is unexpected, wherein
the category identifying unit identifies a first category to which an inputted first word belongs and a second category to which an inputted second word belongs,
the category co-occurrence frequency identifying unit identifies the category co-occurrence frequencies between the first category and categories other than the first category, and
the unexpectedness index calculating unit calculates an index representing the degree that a combination of the first word and the second word is unexpected on the basis of the category co-occurrence frequencies identified by the category co-occurrence frequency identifying unit.

12. The unexpectedness determination system according to claim 11, wherein the index which the unexpectedness index calculating unit calculates is one such that the smaller the category co-occurrence frequency between the first category and the second category is than the category co-occurrence frequencies between the first category and categories other than the first category and the second category, the larger the degree that the combination of the first word and the second word is unexpected becomes.

13. The unexpectedness determination system according to claim 11 further comprising:
a word known/unknown determining unit which determines, on the basis of appearance frequency of a word, whether the word concerned is unknown or known;
a relationship determining unit which determines, on the basis of a co-occurrence frequency between two words, whether there exists relation or not in a combination of the words concerned; and
a total unexpectedness index calculating unit which calculates, on the basis of the index which the unexpectedness index calculating unit calculates, the determination of the word known/unknown determining unit and the determination of the relationship determining unit, an index representing the degree that the combination of the first word and the second word is unexpected, wherein,
in case the word known/unknown determining unit determines that the first word and the second word to be known, the relationship determining unit determines that there exists relation in the combination of the first word and the second word,
and the index which the unexpectedness index calculating unit calculates represents that the degree that the combination of the first word and the second word is unexpected is large, the index which the total unexpectedness index calculating unit calculates will become a numerical value representing that the combination of the first word and the second word is unexpected.

14. The unexpectedness determination system according to claim 11 further comprising:
a category distance calculating unit which calculates distance to a common super-ordinate category to which two words belongs; and
a second unexpectedness index calculating unit which calculates, on the basis of the index which the unexpectedness index calculating unit calculates and the distance which the category distance calculating unit calculates, an index representing the degree that the combination of the first word and the second word is unexpected, wherein
the index which the second unexpectedness index calculating unit calculates is one such that the larger the index which the unexpectedness index calculating unit calculates and the distance which the category distance calculating unit calculate, the larger the degree that the combination of the first word and the second word is unexpected becomes.

15. An unexpectedness determination method comprising:
identifying a first category to which an inputted first word belongs and a second category to which an inputted second word belongs;
identifying category co-occurrence frequencies between the first category and categories other than the first category; and
calculating an index representing a degree representing that a combination of the first word and the second word is unexpected on the basis of the category co-occurrence frequencies, wherein
the index by the calculation concerned is one such that the smaller the category co-occurrence frequency between the first category and the second category is than the category co-occurrence frequencies between the first category and categories other than the first category and the second category, the larger the degree that the combination of the first word and the second word is unexpected becomes.

16. The unexpectedness determination method according to claim 15 further comprising:
determining, on the basis of appearance frequency of the first word and the second word, whether the respective words concerned are unknown or known;
determining, on the basis of a co-occurrence frequency between the first word and the second word, whether there exists relation or not in a combination of the words concerned; and
calculating, on the basis of the index and the two determinations, a total index representing the degree that the combination of the first word and the second word is unexpected, wherein
in case the first word and the second word are determined to be known, it is determined that there exists relation in the combination of the first word and the second word, and the index represents that the degree that the combination of the first word and the second word is unexpected is large, the total index concerned by the calculation concerned will become a numerical value representing that the combination of the first word and the second word is unexpected.

17. The unexpectedness determination method according to claim 15 further comprising:
calculating distance to a common super-ordinate category to which the first word and the second word belong; and
calculating, on the basis of the index and the distance, a second index representing the degree that the combination of the first word and the second word is unexpected, wherein
the second index concerned by the calculation concerned is one such that the larger the index and the distance are, the larger the degree that the combination of the first word and the second word is unexpected becomes.

18. A non-transitory computer-readable medium storing a program which causes a computer to execute:
a process which identifies a first category to which an inputted first word belongs and a second category to which an inputted second word belongs;
a process which identifies category co-occurrence frequencies between the first category and categories other than the first category; and
a process which calculates an index representing a degree that a combination of the first word and the second word is unexpected on the basis of the category co-occurrence frequencies, wherein
the index by the calculation concerned is one such that the smaller the category co-occurrence frequency between the first category and the second category is than the category co-occurrence frequencies between the first category and categories other than the first category and the second category, the larger the degree that the combination of the first word and the second word is unexpected becomes.

19. The non-transitory computer-readable medium storing the program according to claim 18 which causes the computer to further execute:
a process which determines, on the basis of appearance frequency of the first word and the second word, whether the respective words concerned are unknown or known;
a process which determines, on the basis of a co-occurrence frequency between the first word and the second word, whether there exists relation or not in a combination of the words concerned; and
a process which calculates, on the basis of the index and the two determinations, a total index representing the degree that the combination of the first word and the second word is unexpected, wherein
in case the first word and the second word are determined to be known, it is determined that there exists relation in the combination of the first word and the second word, and the index represents that the degree that the combination of the first word and the second word is unexpected is large, the total index concerned by the calculation concerned will be a numerical value representing that the combination of the first word and the second word is unexpected.

20. The non-transitory computer-readable medium storing the program according to claim 18 which causes the computer to further execute:
a process to calculate distance to a common super-ordinate category to which the first word and the second word belong; and
a process to calculate, on the basis of the index and the distance, a second index representing the degree that the combination of the first word and the second word is unexpected, wherein
the second index concerned by the calculation concerned is one such that the larger the index and the distance are, the larger the degree that the combination of the first word and the second word is unexpected becomes.

21. An unexpectedness determination system comprising:
category identifying means for identifying a category to which a word belongs;
category co-occurrence frequency identifying means for identifying a category co-occurrence frequency between two categories; and
unexpectedness index calculating means for calculating an index representing a degree that a combination of two words is unexpected, wherein
the category identifying means identifies a first category to which an inputted first word belongs and a second category to which an inputted second word belongs,
the category co-occurrence frequency identifying means identifies the category co-occurrence frequencies between the first category and categories other than the first category, and
the unexpectedness index calculating means calculates an index representing the degree that a combination of the first word and the second word is unexpected on the basis of the category co-occurrence frequencies identified by the category co-occurrence frequency identifying means.
